(19) United States
(12) Patent Application Publication
(10) Pub. No.: US 2011/0156400 A1
(43) Pub. Date: Jun. 30, 2011

(54) Kinetic Energy Rotation System

(76) Inventor: David A. Lowe, Son City, CA (US)

(21) Appl. No.: 12/651,276

(22) Filed: Dec. 31, 2009

(51) Int. Cl. F03D 9/00; F03B 17/04

(52) U.S. Cl. 290/55; 415/916

(57) ABSTRACT

A kinetic energy rotation system is disclosed which comprises a plurality of wind powered generators. A motor rotates the wind powered generators in a horizontal plane and stores kinetic energy due to the rotating mass of the wind powered generators and its support platform. As electricity is generated by the wind powered generators, a portion of the generated electricity is fed back into the motor to maintain the rotation of the wind powered generators. Excess electricity may be redirected to the city's electrical grid, or other local electrical needs.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a kinetic energy rotation system, windmill, and flywheel.

Windmills are generators that harness the energy contained within moving air and converts such energy into electricity. The windmill may have a blade that rotates as the wind passes by the windmill. The rotating blades provide power to a generator to generate electricity that can be used to power an electrical load. Unfortunately, windmills may only be placed in geographical locations that register consistent and strong winds. Otherwise, the inconsistency of the generated electricity may be useless. Additionally, the amount of electricity generated by the windmill may not be sufficient to effectively contribute to local electrical needs.

Accordingly, there is a need in the art for an apparatus to provide consistent and sufficient electricity.

### BRIEF SUMMARY

The kinetic energy rotation system disclosed herein addresses the needs discussed above, discussed below and those that are known in the art.

The kinetic energy rotation system comprises a plurality of wind powered generators attached to a rotating support platform. The rotating support platform and the wind powered generators are rotationally balanced about a vertical rotating axis. The plurality of wind powered generators rotate in a horizontal plane. Initially, an external source of power is supplied to a motor of the kinetic energy rotation system that drives a transmission unit and ultimately the rotating support platform and the plurality of wind powered generators. As the wind powered generators are rotated about the vertical rotating axis, there is a relative movement of wind passing by each of the wind powered generators to provide energy input into each of the wind powered generators. Electricity generated by the wind powered generators may be fed back into the motor to reduce or eliminate the electrical load on the external source going to the motor and to maintain the speed of the wind powered generators about the vertical axis. Excess electricity generated by the wind powered generators may be fed into the city's electrical grid, provide electricity to local areas, or stored in a battery pack, etc.

The kinetic energy rotation system relates to a method of incorporating kinetic energy by which the rotation of the unit creates a steady method for providing its own wind power, thus absolving itself from depending upon the variable geo physical wind. Additionally, the kinetic energy rotation system provides useful, constant energy. The kinetic energy rotation system may be freestanding, composed of sizes from eight feet (8′) to twenty-four feet (24′) in diameter and from eight feet (8′) to twelve feet (12′) in height.

More particularly, in an embodiment, the kinetic energy rotation system may be a windmill. The windmill may comprise a plurality of wind powered generators, horizontally rotating support platform, and a motor. The plurality of wind powered generators may be all oriented in a single rotational direction. The plurality of wind powered generators may generate electricity as the plurality of wind powered generators rotate in the rotational direction. The horizontally rotating support platform may have the plurality of wind powered generators attached equidistantly from a vertical rotating axis of the rotating support platform for balancing the plurality of wind powered generators. The motor may be attached to the horizontally rotating support platform for rotating the horizontally rotating support platform in the rotational direction to adjust relative wind speed with respect to the plurality of wind powered generators for optimal performance of the wind powered generators.

The windmill may further comprise an electrical output in electrical communication with the plurality of wind powered generators to direct the electricity generated by the plurality of wind powered generators to an electrical load. The electrical load may be a rechargeable battery, an electrical grid, a home's electrical power supply or the motor.

There may be eight wind powered generators mounted to the rotating support platform. The horizontally rotating support platform may be aerodynamically shaped in the rotating direction to reduce drag and increase drag in the opposite direction. The rotating support platform may be a plurality of support arms. A leading edge of each arm may have a convex surface and a trailing edge of each arm having a concave surface.

Additionally, in another embodiment, the kinetic energy rotation system may be a flywheel. The flywheel may comprise a plurality of wind powered generators, a horizontally rotating support platform and a motor. The plurality of wind powered generators may be all oriented in a single rotational direction. The plurality of wind powered generators may generate electricity as the plurality of wind powered generators rotate in the rotational direction. The horizontally rotating support platform may have wind powered generators attached thereto equidistantly from a vertical rotating axis of the rotating support platform for balancing the plurality of wind powered generators. The motor may be attached to the horizontally rotating support platform for rotating the horizontally rotating support platform and the plurality of wind powered generators in the rotational direction to induce relative wind speed with respect to the plurality of wind powered generators. The motor rotates the support platform and generators to store kinetic energy for retrieval at a later time and the electricity generated by the generators is redirected to the motor to maintain rotation of the support platform and generators to an optimal wind speed.

The flywheel may further comprise an electrical output in electrical communication with the plurality of wind powered generators to direct the electricity generated by the plurality of wind powered generators to an electrical load. The load may be a rechargeable battery, an electrical grid, a home's electrical power supply, the motor, or other utility needs.

There may be eight wind powered generators. The horizontally rotating support platform may be aerodynamically shaped in the rotating direction to reduce drag. The flywheel may further comprise an enclosure with the plurality of wind powered generators and support platform disposed within the enclosure.

Moreover, a kinetic energy rotation system is disclosed. The kinetic energy rotation system may comprise a plurality of wind powered generators, a horizontally rotating support platform and a motor. The plurality of wind powered generators may be all oriented in a single rotational direction. The plurality of wind powered generators may generate electricity as the plurality of wind powered generators rotate in the rotational direction. The horizontally rotating support platform may have wind powered generators attached thereto equidistantly from a vertical rotating axis of the rotating support platform for balancing the plurality of wind powered generators. The motor may be attached to the horizontally rotating support platform for rotating the horizontally rotating support platform and the plurality of wind powered generators in the rotational direction to induce relative wind speed with respect to the plurality of wind powered generators. The motor rotates the support platform and generators to store kinetic energy for retrieval at a later time and the electricity generated by the generators is redirected to the motor to increase rotation of the support platform and generators to an optimal relative wind speed.

The system may further comprise an enclosure with the plurality of wind powered generators and the support platform disposed within the enclosure.

Two or more sets of wind powered generators and support platforms may be stacked upon each other.

The system may further comprise an electrical output in electrical communication with the plurality of wind powered generators to direct the electricity generated by the plurality of wind powered generators to an electrical load. The electrical load may be a rechargeable battery, an electrical grid, a home's electrical power supply, the motor or other utility needs.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a kinetic energy rotation system;

FIG. 1A is partial view of an alternate embodiment of the kinetic energy rotation system shown in FIG. 1;

FIG. 1B is another embodiment of the kinetic energy rotation system shown in FIG. 1;

FIG. 2 is a cross sectional view of the kinetic energy rotation system shown in FIG. 1;

FIG. 3 is a cross sectional view of a rotating support arm shown in FIG. 1;

FIG. 4 is a schematic view of the kinetic energy rotation system shown in FIG. 1;

FIG. 5 is a top view of the kinetic energy rotation system shown in FIG. 1; and

FIG. 6 is a cross sectional view of a rotating support arm shown in FIG. 5.

### DETAILED DESCRIPTION

Referring now to the drawings, a kinetic energy rotation system 10 is shown. A motor 12 rotates wind powered generators 14a-h in the direction of arrow 16 to rotate blades 18a-h so that the relative wind speed 20 of the wind passing the wind powered generators 14 is within the optimal range as designed for the wind powered generators 14. Each of the wind powered generators 14a-h are in electrical communication with an output to supply electricity to an electrical load. The electricity may be redirected back into the motor 12 to maintain the relative wind speed 20 within the optimal range. Additionally, the electricity may be directed to a rechargeable battery to store the energy generated by the wind powered generators 14a-h for later use. Also, the electricity may be placed onto the city's electrical grid to provide electricity to the surrounding area.

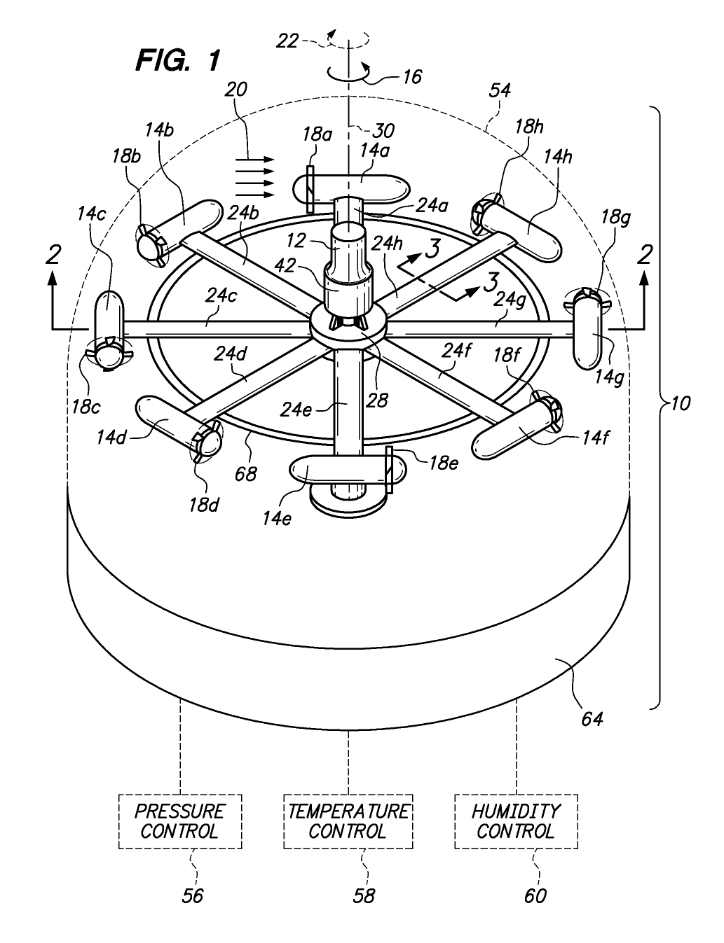

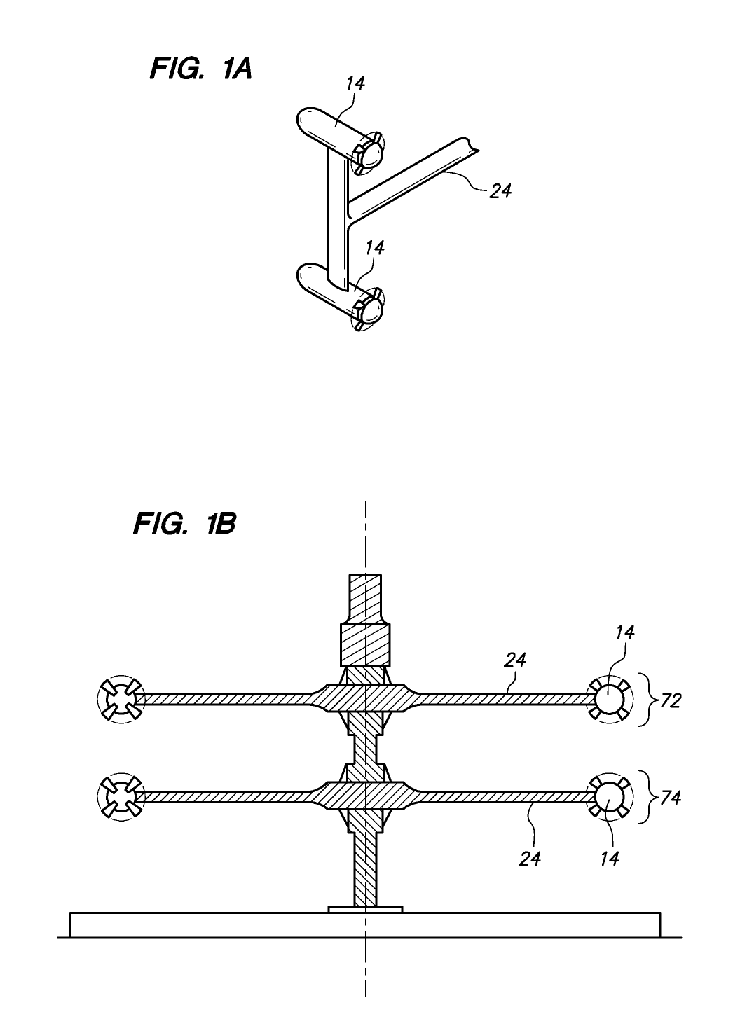

More particularly, referring now to FIG. 1, the kinetic energy rotation system 10 may comprise eight (8) wind powered generators 14a-h. Each of these wind powered generators 14a-h may be oriented in the same direction. By way of example and not limitation, from a top view of the kinetic energy rotation system 10 shown in FIG. 1, the wind powered generators 14a-h are oriented in the counterclockwise direction so that the wind powered generators 14a-h generate electricity when the wind powered generators 14a-h are rotated in the counterclockwise direction shown by arrow 16 in FIG. 1. The orientation of the wind powered generators 14a-h may also be reversed so that the wind powered generators 14a-h are oriented in the clockwise direction as shown by arrow 22 shown in hidden line. The wind powered generators 14a-h may be sized and have a particular capacity for generating electricity as defined by the output requirements. The generators 14 may be magnetic, induction or other types. For example, the wind powered generators 14 may be a lightweight low-drag ram air turbine sold by Ghetzler Aero-Power or other manufacturer.

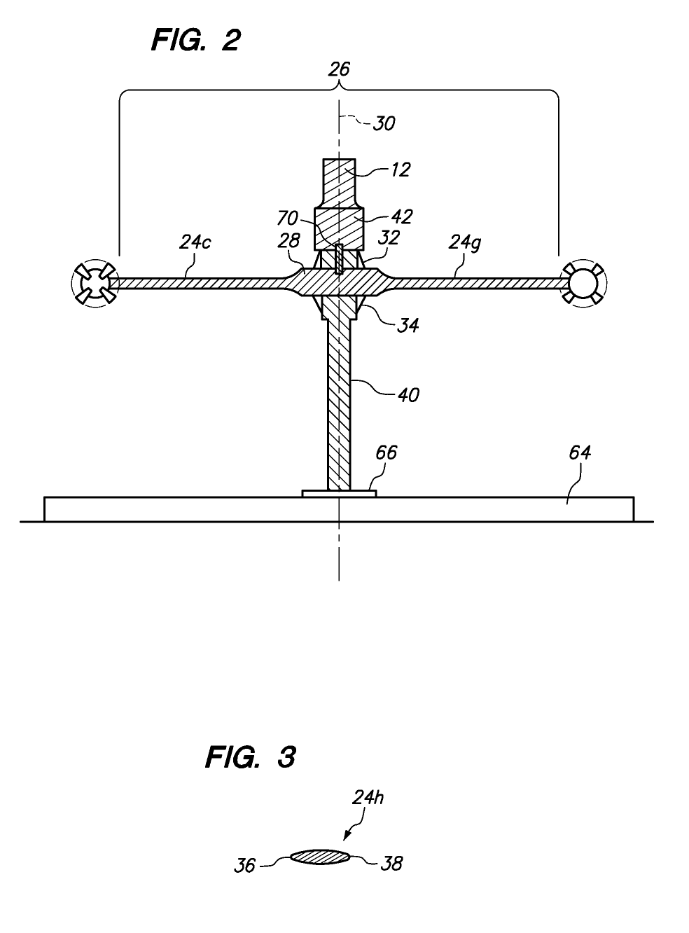

The wind powered generators 14a-h may be attached to a distal end portion of rotating support arms 24a-h. It is also contemplated that two (2) wind powered generators 14 may be stacked upon each other and attached to one (1) rotating support arm 24, as shown in FIG. 1A. Alternatively, it is contemplated that a first assembly 72 of rotating support arms 24 and wind powered generators 14 may be stacked upon a second assembly 74, as shown in FIG. 1B. A horizontal periphery support 68 may be attached between each of the rotating support arms 24a-h for stability. The horizontal periphery support 68 may be balanced about the vertical axis 30. The rotating support arms 24a-h may be designed for minimum air resistance to carry the static and dynamic loads of the system 10. The rotating support arms 24a-h and the horizontal periphery support 68 may be fabricated from aluminum alloy, titanium alloy, carbon fiber, honeycomb combinations, fiberglass combinations or combinations thereof. The rotating support arms 24a-h may be angularly equidistant from each other so that the wind powered generators 14a-h are also equidistantly spaced apart from each other. The rotating support arms 24a-h and the horizontal periphery support 68 define a rotating support platform 26 (see FIG. 2). Other configurations of the rotating support platform 26 are also contemplated.

The rotating support arms 24a-h may be fixedly connected to a rotating disc 28 which is rotationally balanced about the vertical rotating axis 30. The rotating disc 28 may be fabricated from the same material as the rotating support arm, specifically, aluminum alloy, titanium alloy, carbon fiber, honeycomb combinations, fiberglass combinations or combinations thereof. Each of the wind powered generators 14a-h may also be equidistantly offset from the vertical rotating axis 30 about which the wind powered generators 14a-h rotate. The equidistant angular spacing between adjacent wind powered generators 14a-h and the equidistant spacing of each of the wind powered generators 14a-h from the vertical rotating axis 30 provide a balanced rotating support platform 26 about the vertical axis 30. As shown in FIG. 2, the rotating support platform 26 is placed in a horizontal direction such that the rotating support platform 26 rotates within a horizontal plane. The rotating support platform 26 is supported by upper and lower bearings 32, 34. In particular, the upper and lower bearings 32, 34 contact the rotating disc 28 and allow the rotating disc 28 to rotate about the vertical axis 30.

The cross section of the rotating support arm 24 may have an aerodynamic shape. An example of the aerodynamic shape is shown in FIG. 3. Leading and trailing edges 36, 38 may have rounded surfaces to minimize turbulent air flow passing the rotating support arm 24h. Each of the rotating support arms 24a-g may also have an aerodynamic shape similar or identical to the aerodynamic shape of the rotating support arm 24h. The purpose is to reduce the load on the motor 12 required to rotate the wind powered generators 14a-h and increase the efficiency of the kinetic energy rotation system 10.

The rotating support platform 26 may be rotationally mounted to a vertical stationary support 40. The vertical stationary support 40 provides support to the rotating support platform 26 above grade or above other structural systems. The vertical stationary support 40 may be fabricated from aluminum tubing, steel tubing or high strength fiberglass configurations. The vertical stationary support 40 may receive the lower bearing 34. The rotating disc 28 may be fully supported vertically on the lower bearing 34. The upper bearing 32 is compressed onto the rotating disc 28 to stabilize the rotating support platform 26 as the wind powered generators 14 are rotated about the vertical axis 30. The upper and lower bearings 32, 34 may be roller bearings, ball bearings, magnetic bearings, pneumatic bearings. Other means of rotationally supporting the rotating support platform 26 are also contemplated such as magnetic levitation, etc. The means of rotationally supporting the rotating support platform 26 may be designed for maximum efficiency, low maintenance and a long life. The rotating disc 28 may be mechanically coupled to the motor 12 by way of a transmission unit 42 and drive shaft 70, as shown in FIG. 2. The drive shaft 70 may be fabricated from high strength steel for required loading capacity.

The motor 12 may be powered by electricity supplied by an external source (e.g., city's electrical grid, local solar power, wind power, etc.) and/or the electricity generated by the kinetic energy rotation system 10. The purpose of the motor 12 is to provide rotational input to the transmission unit 42. The rotational input provided by the motor 12 may be variable due to the varying power of the electricity of the external source. The transmission unit 42 smoothes the variations and provides constant rotary speed to the rotating support platform 26.

The vertical stationary support 40 may be attached to a platform 64 of the kinetic energy rotation system 10 as shown in FIG. 2. In particular, the bottom end portion of the vertical stationary support 40 may have a base 66. The base 66 may be welded or bolted with insert bolts to the platform 64 of the kinetic energy rotation system 10. The platform 64 of the kinetic energy rotation system 10 may be used to level the kinetic energy rotation system 10 and may be prefabricated from fiberglass or with various polyurethane materials or metal.

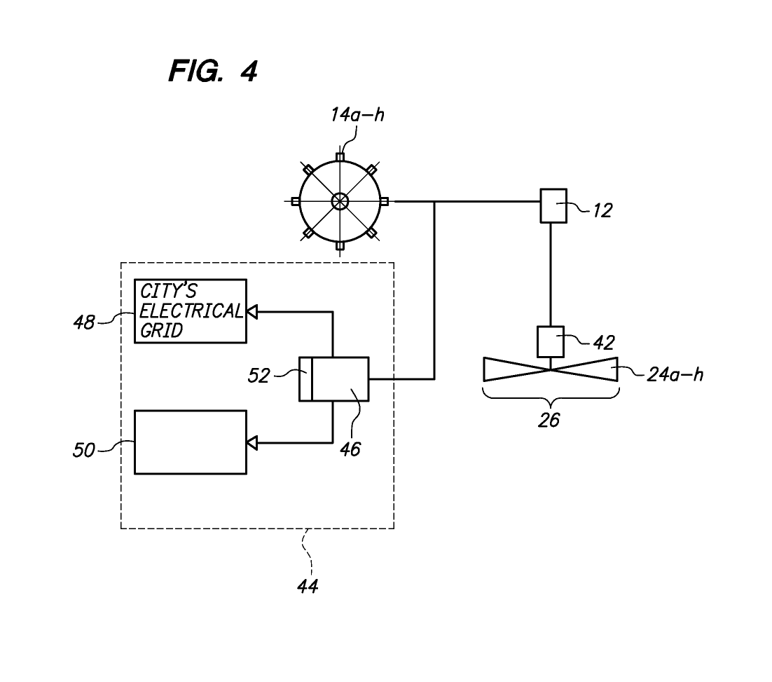

The kinetic energy rotation system 10 may operate in various modes. For example, referring back to FIG. 1, the kinetic energy rotation system 10 may be used to produce energy that can be placed back upon the city's electrical grid which is schematically shown in FIG. 4. By way of example and not limitation, electricity from an external source (e.g., city's electrical grid, traditional windmill, etc.) may be used to initially power the motor 12 which rotates the wind powered generators 14a-h to the optimal speed such that the relative wind speed of the air passing the wind powered generators 14a-h is within the optimal range. The external electrical source drives the motor 12 which is in mechanical communication with the transmission unit 42. The transmission unit 42 rotates the rotating support platform 26 and indirectly, the rotating support arms 24a-h. The wind powered generators 14a-h rotate and due to the relative wind speed of the wind passing the wind powered generators 14a-h, the wind powered generators 14a-h generate electricity that can be directed to an electrical load 44. The electrical load 44 may be a rechargeable battery pack 46, the city's electrical grid 48, and/or other local electrical needs 50. The rechargeable battery pack 46 may be a battery storage unit currently in the market or developed in the future. A switch gear inverter 52 along with other electronics may be used to direct the produced electricity to any one or more of the electrical loads 46, 48, 50 or back to the motor 12. The kinetic energy rotation system 10 may generate all of the energy required to drive motor 12 to rotate the wind powered generators 14a-h within the optimal range while providing excess energy that can be diverted to a rechargeable battery 46, the city's electrical grid 48 or other local electrical needs 50.

The kinetic energy rotation system 10 may be encapsulated by an enclosure 54 to protect the kinetic energy rotation system 10 from natural elements and weather. The enclosure may be prefabricated and developed for a single kinetic energy rotation system 10 depending upon the environmental location, use, etc. For example, the enclosure 54 may be fabricated from aluminum framing with insulation covering, formed honey comb with insulated Styrofoam, polyethelene finish and carbon fiber. Accordingly, the kinetic energy rotation system 10 disposed within the enclosure 54 may be used in any geographical area in the world and outer space. The kinetic energy rotation system 10 may be resistant to sand, heat, etc. If the enclosure 54 is waterproof, the kinetic energy rotation system 10 may be located in a humid or fluid environment (e.g., underwater). Additionally, a pressure control 56, temperature control 58 and/or a humidity control 60 may be in communication with the enclosure 54 to control the pressure within the enclosure 54 by way of the pressure control 56, to control the temperature within the enclosure 54 by way of the temperature control 58, and to control the humidity within the enclosure 54 by way of the humidity control 60.

The pressure control 56 may comprise a vacuum/compressor pump unit to maintain proper pneumatic pressure within the enclosure 54. A pressure sensor may also provide feedback to the pressure control 56. Additionally, there may be a pressure control valve located on the enclosure 54 for releasing gas from within the enclosure 54 to reduce the pressure. An electronic unit may control the vacuum/compressor pump unit to maintain the appropriate pressure. The vacuum/compressor pump unit may maintain optimal pressure within the enclosure 54 for rotating efficiency despite pressure differences due to location or weather changes. The vacuum/compressor pump unit may maintain the pressure within the enclosure 54 so that the pressure within the enclosure 54 is greater than pressure at sea level. This allows design capacity and efficiency to be increased. An inert gas or gas other than air may be filled within the enclosure. The particular gas may provide for increased efficiency due to the gas's viscosity and specific gravity relative to pressure.

The temperature control 58 may include a temperature sensing element, combination electric cooling/heat pump unit that is in electrical communication with the temperature sensing element. Based on the temperature sensed by the temperature sensing element, the electronic unit may also control the combination electric cooling/heat pump unit to cool or heat the interior of the enclosure 54.

In a different operation of the kinetic energy rotation system 10, the wind powered generators 14 and the rotating support arms 24 may behave as a flywheel to store kinetic energy within the rotating support platform 26 and the wind powered generators 14 for later conversion into electricity when needed. Electricity from an external source is applied to the motor 12. The motor 12 increases the rotational speed of the rotating support platform 26 and the wind powered generators 14 until the desired amount of kinetic energy is stored within the system 10. Preferably, the rotating support platform 26 and the wind powered generators 14 are rotated until the relative wind speed 20 is within the optimal range of the wind powered generators 14. The electricity generated by the wind powered generators 14 may be diverted back to the motor 12 to maintain the optimal rotational velocity. When a load 44 requires electricity, the switch gear inverter 52 may redirect electricity to the load 44 and would convert some of the kinetic energy stored within the rotating support platform 26 and rotating wind powered generators 14 into electricity to power the electrical load 44. As such, the kinetic energy rotation system 10 may be utilized as a flywheel to store kinetic energy and to convert that kinetic energy into electricity when desired or needed.

Referring now to FIG. 5, an embodiment of the kinetic energy rotation system 10 is shown. No enclosure 54 is used to encapsulate the kinetic energy rotation system 10. Rather, the kinetic energy rotation system 10 is exposed to geo physical wind forces 62. The motor 12 rotates the rotating support arms 24a-h and wind powered generators 14a-h in the direction of arrow 16. The geo physical wind 62 increases a relative wind speed 20 for some of the generators 14 such as wind powered generator 14b. In contrast, the geo physical wind 62 slows down the relative wind speed 20 for other generators such as wind powered generator 14f. The geo physical wind 62 behaves differently for the other wind powered generators 14a-h. Accordingly, the geo physical wind 62 may bring the wind speed 20 out of the optimal range as designed for the wind powered generator 14. A logic control unit may be used to adjust the rotational speed of the wind powered generators 14 based on the strength of the geo physical wind 62 so that the kinetic energy rotation system 10 can harness the energy within the geo physical wind 62. Even during changes in direction of the geo physical wind 62 such as reflected by 62a in FIG. 5, the constantly changing pattern of the geo physical wind 62 will increase the speed 20 for some of the wind powered generators 14 and decrease the wind speed 20 for other generators 14. Since the generators 14 are disposed symmetrically about axis 30, the changes in direction don't affect the efficiency of the kinetic energy rotation system 10.

Ailerons 74a-h may be attached to the trailing end portion of the rotating support arms 24a-h. These ailerons 74a-h may be configured and controlled by a computer in response to signals sent by a wind direction sensor and a wind velocity sensor to improve rotating efficiency. The ailerons 74a-h compensate for changes in the geophysical wind direction and velocity.

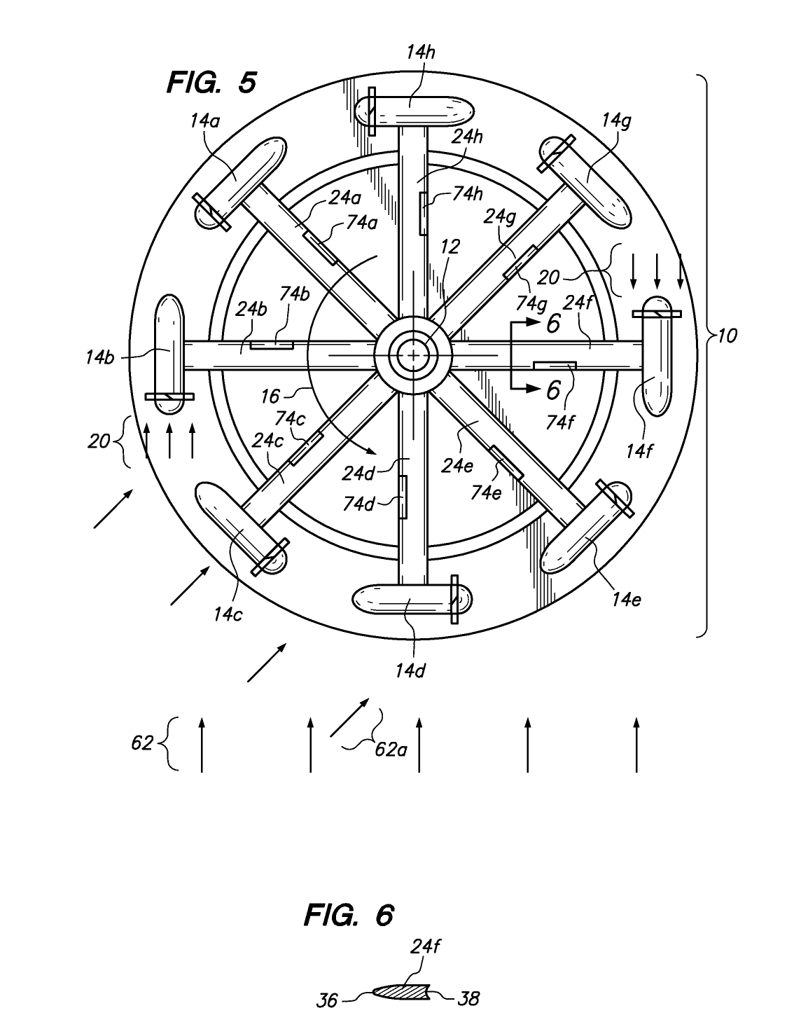

Referring now to FIG. 6, a cross sectional view of the rotating support arm 24f of the kinetic energy rotation system 10 in FIG. 5 is shown. The leading edge of the rotating support arms 24a-h may have an aerodynamic shape such as a round curved shape to reduce aerodynamic drag. However, the trailing edge 38 of the rotating support arms 24a-f may have a concave surface to increase drag. In this manner, as the geo physical wind 62 contacts the trailing edge 38 of the rotating support arms 24a-h, the geo physical wind 62 may help in rotating the rotating support arms 24a-h. The geo physical wind 62 increases the net output of electricity that can be generated by the wind powered generators 14. Also, despite changes in wind direction, the increase in net output may remain about the same since the rotating parts are symmetrical about the vertical axis 30.

The above description is given by way of example, and not limitation. Given the above disclosure, one skilled in the art could devise variations that are within the scope and spirit of the invention disclosed herein, including various ways of forming the enclosure. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A windmill comprising:
a plurality of wind powered generators which are all oriented in a single rotational direction, the plurality of wind powered generators generating electricity as the plurality of wind powered generators rotate in rotational direction;
a horizontally rotating support platform with the plurality of wind powered generators attached equidistantly from a vertical rotating axis of the rotating support platform for balancing the plurality of wind powered generators; and
a motor attached to the horizontally rotating support platform for rotating the horizontally rotating support platform in the rotational direction to adjust relative wind speed with respect to the plurality of wind powered generators for optimal performance of the wind powered generators.

2. The windmill of claim 1 further comprising an electrical output in electrical communication with the plurality of wind powered generators to direct the electricity generated by the plurality of wind powered generators to an electrical load.

3. The windmill of claim 2 wherein the electrical load is a rechargeable battery, an electrical grid, a home's electrical power supply, the motor or other utility needs.

4. The windmill of claim 1 wherein the plurality of wind powered generators comprises about eight wind powered generators.

5. The windmill of claim 1 wherein the horizontally rotating support platform is aerodynamically shaped in the rotating direction to reduce drag.

6. A flywheel comprising:
a plurality of wind powered generators which are all oriented in a single rotational direction, the plurality of wind powered generators generating electricity as the plurality of wind powered generators rotate in the rotational direction;
a horizontally rotating support platform with the plurality of wind powered generators attached thereto equidistantly from a vertical rotating axis of the rotating support platform for balancing the plurality of wind powered generators; and
a motor attached to the horizontally rotating support platform for rotating the horizontally rotating support platform and the plurality of wind powered generators in the rotational direction to induce relative wind speed with respect to the plurality of wind powered generators;
wherein the motor rotates the support platform and generators to store kinetic energy for retrieval at a later time and the electricity generated by the generators is redirected to the motor to increase rotation of the support platform and generators for maintaining an optimal wind speed.

7. The flywheel of claim 6 further comprising an electrical output in electrical communication with the plurality of wind powered generators to direct the electricity generated by the plurality of wind powered generators to an electrical load.

8. The flywheel of claim 7 wherein the load is a rechargeable battery, an electrical grid, a home's electrical power supply, the motor or other utility needs.

9. The flywheel of claim 6 wherein the plurality of wind powered generators comprises about eight wind powered generators.

10. The flywheel of claim 6 wherein the horizontally rotating support platform is aerodynamically shaped in the rotating direction to reduce drag.

11. The flywheel of claim 10 wherein rotating support platform is a plurality of arms, a leading edge of each arm having a convex surface and a trailing edge of each arm having a concave surface.

12. The flywheel of claim 6 further comprising an enclosure with the plurality of wind powered generators and support platform disposed within the enclosure.

13. A kinetic energy rotation system comprising:
a plurality of wind powered generators which are all oriented in a single rotational direction, the plurality of wind powered generators generating electricity as the plurality of wind powered generators rotate in the rotational direction;
a horizontally rotating support platform with the plurality of wind powered generators attached thereto equidistantly from a vertical rotating axis of the rotating support platform for balancing the plurality of wind powered generators; and
a motor attached to the horizontally rotating support platform for rotating the horizontally rotating support platform and the plurality of wind powered generators in the rotational direction to induce relative wind speed with respect to the plurality of wind powered generators;
wherein the motor rotates the support platform and generators to store kinetic energy for retrieval at a later time and the electricity generated by the generators is redirected to the motor to increase rotation of the support platform and generators to an optimal relative wind speed.

14. The system of claim 13 further comprising an enclosure with the plurality of wind powered generators and the support platform disposed within the enclosure.

15. The system of claim 13 further comprising two or more sets of wind powered generators and support platforms stacked upon each other.

16. The system of claim 13 further comprising an electrical output in electrical communication with the plurality of wind powered generators to direct the electricity generated by the plurality of wind powered generators to an electrical load.

17. The system of claim 13 wherein the electrical load is a rechargeable battery, an electrical grid, a home's electrical power supply, the motor or other utility needs.
